(19) United States
(12) Patent Application Publication
(10) Pub. No.: US 2026/0178448 A1
(43) Pub. Date: Jun. 25, 2026

(54) STORAGE SYSTEM AND DATA PROTECTION METHOD

(71) Applicant: Hitachi Vantara, Ltd., Kanagawa-ken (JP)

(72) Inventors: Sadahiro SUGIMOTO, Tokyo (JP); Takashi NAGAO, Tokyo (JP); Norio SHIMOZONO, Tokyo (JP)

(21) Appl. No.: 19/311,571

(22) Filed: Aug. 27, 2025

(30) Foreign Application Priority Data
Dec. 20, 2024 (JP) 2024-225245

(51) Int. Cl. G06F 11/14

(52) U.S. Cl. CPC G06F 11/1458; G06F 2201/805

(57) ABSTRACT

Each of a plurality of storage controllers includes a first memory protection scheme in which logs related to the writing and updating of data in memory are generated and stored in an in-memory queue and in which the logs are extracted from the queue and written to a non-volatile storage medium. When the data in the memory is to be protected using the first memory protection scheme, the storage controller controls, according to the capacity of the logs stored in the queue, the execution of a first process for storing logs in the queue and a second process for extracting logs from the queue and writing the logs to the storage medium.

### CROSS-REFERENCE TO PRIOR APPLICATION

This application relates to and claims the benefit of priority from Japanese Patent Application number 2024-225245, filed on Dec. 20, 2024 the entire disclosure of which is incorporated herein by reference.

### BACKGROUND OF THE INVENTION

### 1. Field of the Invention

The present invention relates to a storage system and a data protection method.

### 2. Description of the Related Art

A storage system is required to have high performance and high reliability. In order to improve the performance of a storage system, it is useful to perform writeback, in which there is a response by a storage controller to a host at the stage where the writing of write data from the host to cache memory is complete, and the data is subsequently written to a drive.

In addition, JP 2024-124097 A discloses the following technology to improve the reliability of a storage system in writeback. That is, while one of the duplicated storage controllers is blocked, updated content of the cache memory in another storage controller is written to the drive as logs to render the data non-volatile. As a result, even if the other storage controller fails, the data is prevented from being lost.

### SUMMARY OF THE INVENTION

Using the above-described conventional technique, logs of the updated content of the cache memory are temporarily stored in a queue before being written to the drive.

However, when the queue is full in a state where all the processor cores are to execute other processes awaiting log storage, it is not possible to secure a processor core for dispatch and start the process for writing logs to the drive. As a result, there is a problem that no logs are written to the drive and logs accumulate in the queue.

The present invention was conceived of in view of the above problems, and an object thereof is to prevent, in writeback of a storage system, logs from accumulating in a queue for storing updated content logs in cache memory.

In order to achieve the above object, the present invention is, according to one aspect, a storage system including a non-volatile storage device for storing user data; and a plurality of storage controllers for controlling reading from and writing to the storage device, characterized in that each of the plurality of storage controllers includes a processor and a memory, in that the storage controller includes a first memory protection scheme in which logs related to the writing and updating of data in the memory are generated and stored in a queue and in which the logs are extracted from the queue and written to a non-volatile storage medium to protect the data in the memory, and in that, when the data in the memory is to be protected using the first memory protection scheme, the storage controller controls, according to the capacity of the logs stored in the queue, the execution of a first process for storing the logs in the queue and a second process for extracting the logs from the queue and writing the logs to the storage medium.

According to the present invention, for example, in writeback of a storage system, it is possible to prevent logs from accumulating in a queue for storing updated content logs in cache memory.

### BRIEF DESCRIPTION OF THE DRAWINGS

FIG. 1 is a diagram illustrating a configuration of an entire system including a storage system according to an embodiment;

FIG. 2 is a diagram illustrating an outline of a write operation when a single controller is blocked according to the embodiment;

FIG. 3 is a diagram illustrating a configuration of a memory of the storage system according to the embodiment;

FIG. 4 is a diagram illustrating an outline of process assignment by a scheduler according to the embodiment;

FIG. 5 is a diagram illustrating an outline of a log backup request queue according to the embodiment;

FIG. 6 is a diagram illustrating an outline of log backup request queue thresholds according to the embodiment;

FIG. 7 is a flowchart illustrating write processing according to the embodiment;

FIG. 8 is a flowchart illustrating cache data update processing according to the embodiment;

FIG. 9 is a flowchart illustrating log creation processing according to the embodiment;

FIG. 10 is a flowchart illustrating control information update processing according to the embodiment;

FIG. 11 is a flowchart illustrating process scheduling processing according to the embodiment;

FIG. 12 is a flowchart illustrating log backup processing according to the embodiment; and

FIG. 13 is a flowchart illustrating destage speed adjustment processing according to the embodiment.

### DESCRIPTION OF THE PREFERRED EMBODIMENTS

Hereinafter, an embodiment according to the present invention will be described with reference to the drawings. The embodiment relates to, for example, a storage system that includes a plurality of storage controllers.

### Configuration of Entire System Including Storage System 100 According to Embodiment

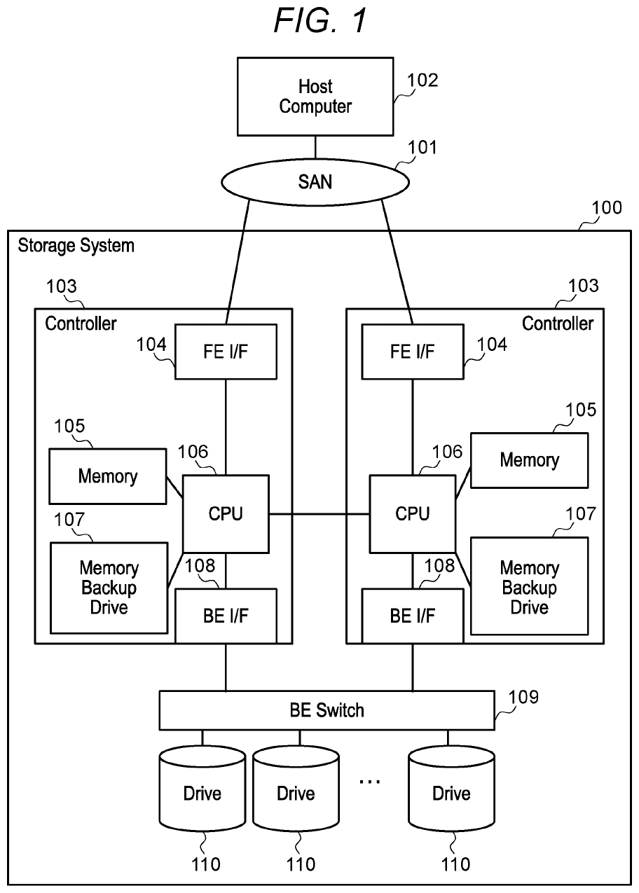

FIG. 1 is a diagram illustrating a configuration of an entire system that includes a storage system 100 according to an embodiment. The storage system 100 according to the present embodiment includes a plurality of controllers 103 and a drive 110 which is a storage device. The storage controller 103 is a device fulfilling the function of providing a host computer (hereinafter, host) with volumes serving as targets for data reading and writing.

The drive 110 is, for example, a solid state drive (SSD) using a flash memory as a storage medium, a hard disk drive (HDD) using a magnetic disk as a storage medium, or the like.

The storage controller 103 includes a CPU 106, a memory 105, a memory backup drive 107, a front-end interface (FE I/F) 104, and a back-end interface (BE I/F) 108.

The CPU 106 is an example of a processor, and includes a plurality of CPU cores 106c that execute various dispatched processes described below.

The memory 105 is, for example, a semiconductor memory such as a dynamic random access memory (DRAM). The memory backup drive 107 is, for example, a drive such as an SSD and is used to back up the contents of the memory 105 when external power is lost, and so forth.

The front-end interface 104 is, for example, a Fibre Channel host bus adapter (HBA) or a network interface controller (NIC). The back-end interface 108 is, for example, an SAS HBA, a PCI Express (hereinafter, PCIe) adapter, or an NIC. Each storage controller 103 and the drive 110 are connected by a switch (BE Switch) 109, for example. The CPUs 106 of the plurality of controllers are connected by an interconnect such as a PCIe interconnect, for example.

Note that the CPUs 106 may be connected to each other via, for example, a PCIe switch. The storage system 100 is connected to a storage area network (SAN) 101 such as a Fibre Channel or Ethernet (registered trademark) network, and a host 102 is also connected to the SAN 101. The SAN 101 may include a switch or the like. In addition, a plurality of hosts 102 may be connected to the SAN 101.

### Outline of Write Operation When Single Controller Is Blocked According to Embodiment

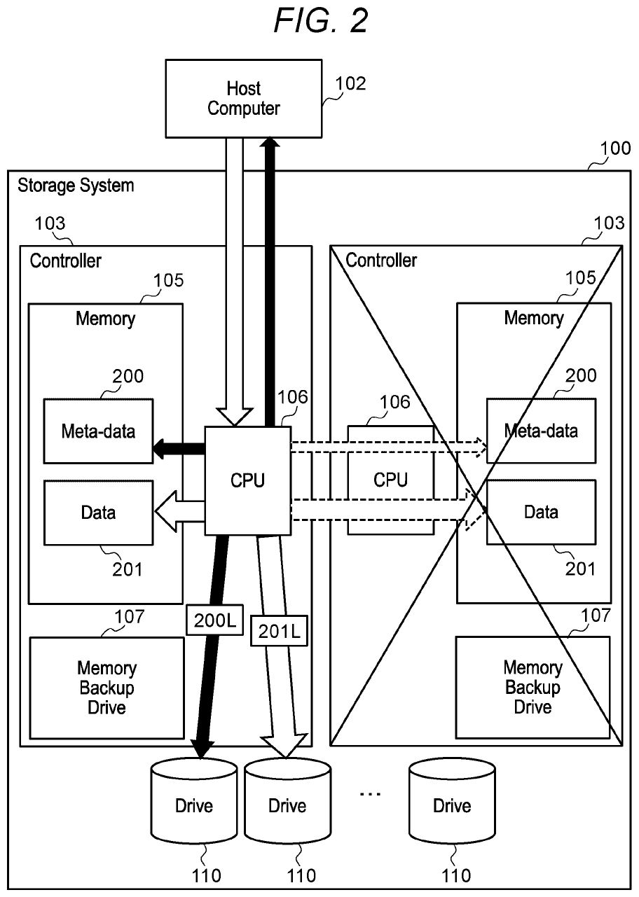

FIG. 2 is a diagram illustrating an outline of a write operation when a single controller is blocked according to the embodiment.

The CPU 106 of the storage controller 103 according to the present embodiment receives data 201 from the host 102 in response to a write request from the host 102, and writes the data 201 to the memory 105 in its own storage controller 103. In addition, the CPU 106 updates the control information (metadata) 200 in the memory 105 in its own storage controller 103. Similarly, the CPU 106 also writes the same data 201 to the memory 105 in the other controller. The CPU 106 also updates the control information 200 in the memory 105 in the other controller. Thereafter, the CPU 106 returns a write completion response to the host 102. In addition, the CPU 106 writes the write data 201 written in the memory 105 to the drive 110 later (destage).

As described above, in a write operation, the storage system 100 prepares for failure of the storage controller 103 by duplicating, between the storage controllers 103, the write data and the control information in the memory 105. This memory protection scheme is an example of a second memory protection scheme in which the storage controller protects in-memory data by copying the in-memory data to another memory of another storage controller corresponding to the storage controller.

Here, as illustrated in FIG. 2, a situation is considered in which only the storage controller 103 included in one storage system 100 normally operates and the other storage controller 103 included in the storage system 100 is blocked due to a failure or the like. This situation is referred to as single controller blockage.

When the single controller is blocked, the CPU 106 of the storage controller 103 that has not failed receives a write request from the host 102, receives the data 201 from the host 102, and writes the data 201 to the memory 105 in its own storage controller 103. Further, the CPU 106 updates the control information 200 in the memory 105.

Further, the CPU 106 writes the updated content of the data 201 to the drive 110 as a log (a cache data logs 201L), and writes the updated content of the control information 200 to the drive 110 as logs (control information logs 200L) (log backup). The CPU 106 then responds to the host 102 that the write has been completed. The memory protection scheme for protecting the in-memory data in this manner when the single controller is blocked is referred to as the “log backup mode”.

The “log backup mode” is an example of a first memory protection scheme in which a storage controller generates a log related to the writing and updating of in-memory data, stores the log in a queue, extracts the log from the queue, and writes the log to a non-volatile storage medium to protect the in-memory data.

The storage controller 103 switches between using either a first memory protection scheme (log backup scheme) or a second memory protection scheme (memory copying scheme) according to operating states such as normal operation and failure of the other storage controller 103. The storage controller 103 then protects the data in the memory 105 by using the switched first memory protection scheme or second memory protection scheme.

Note that, in the present embodiment, it is assumed that the control information logs 200L and the cache data logs 201L are recorded on the drive 110 for storing user data. However, the logs may be recorded on another log storage drive 110 or on the memory backup drive 107 which is a non-volatile medium.

### Configuration of Memory of Storage System 100 According to Embodiment

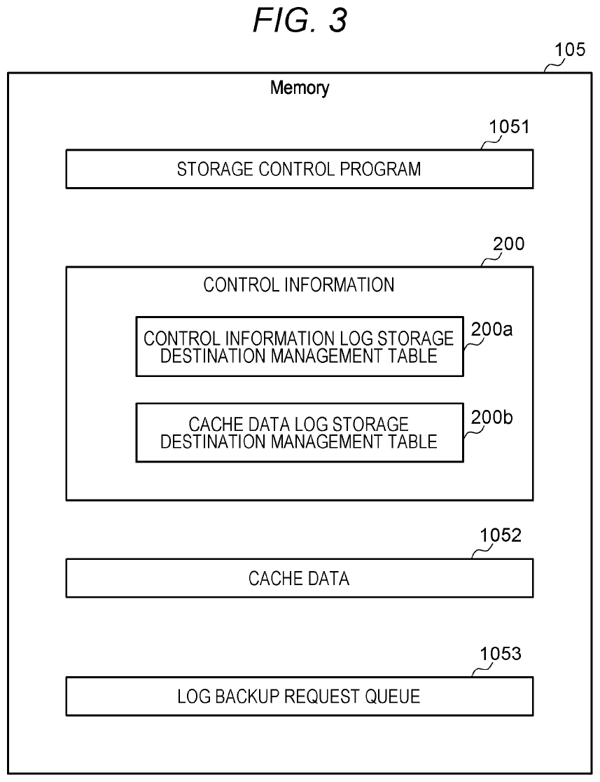

FIG. 3 is a diagram illustrating a configuration of a memory of the storage system 100 according to the embodiment. The memory 105 includes a storage control program 1051, control information 200, cache data 1052, and a log backup request queue 1053.

The storage control program 1051 is a program for controlling the storage system 100 and is executed by the CPU 106.

The control information 200 is data used by the storage control program 1051 to control the execution of a program. The control information 200 includes a control information log storage destination management table 200a and a cache data log storage destination management table 200b.

The control information log storage destination management table 200a manages addresses of storage destinations of the control information log 200L. The cache data log storage destination management table 200b manages the addresses of storage destinations of the cache data logs 201L. In addition, the control information 200 includes cache control information that includes correspondence relationships between the addresses of the cache data 1052 and the logical addresses (LBA) in the volumes, and states (dirty/clean) of the cache data, and the like. The control information 200 also includes configuration information including types and capacities of drives, types and configurations of RAID groups, and the like, and states (normal or blocked) of each controller, and so forth.

The cache data 1052 contains data 201.

Outline of Log Backup Request Queue 1053 According to Embodiment

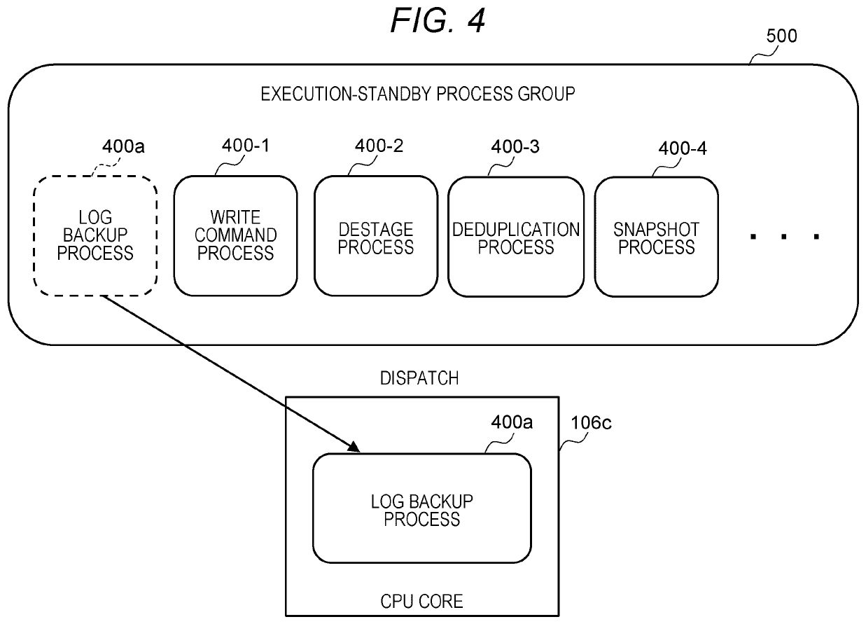

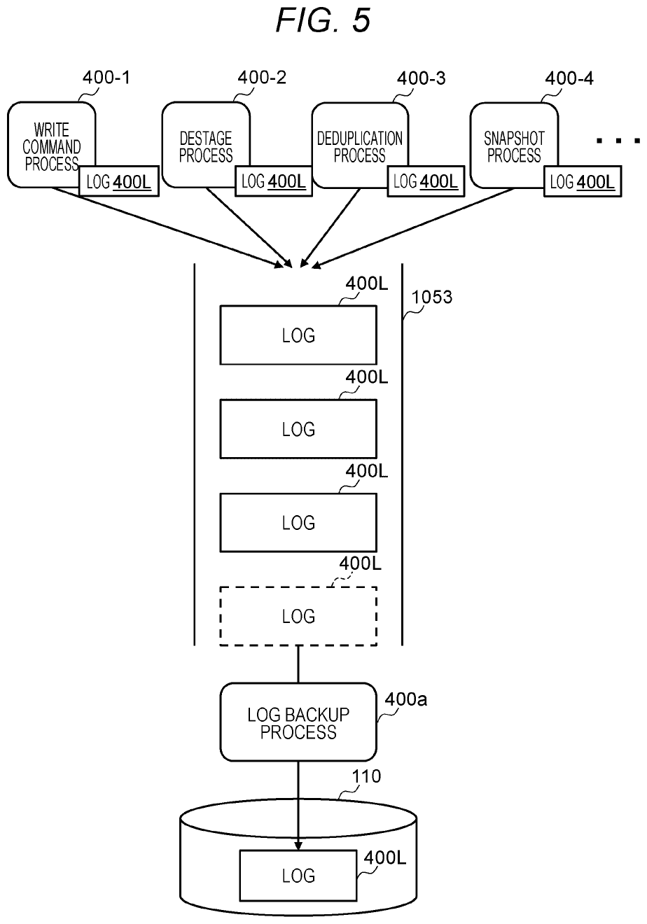

FIG. 4 is a diagram illustrating an outline of process assignment by a scheduler according to the embodiment. FIG. 5 is a diagram illustrating an outline of the log backup request queue 1053 according to the embodiment.

As illustrated in FIG. 4, each process 400 included in the execution-standby process group 500 is selected by the scheduler executed by the CPU 106 according to the schedule and dispatched to the CPU core 106c of the CPU 106. The processes 400 include a first process such as a write command process 400-1, a destage process 400-2, a deduplication process 400-3, and a snapshot process 400-4, and a second process such as a log backup process 400a.

The log backup process 400a stores, in the drive 110, the logs 400L stored in the log backup request queue 1053.

In response to an I/O request from the host 102, the write command process 400-1 writes the data 201 and the control information 200 to the memory 105. In addition, the write command process 400-1 writes the data 201 and the control information 200 to the memory 105 in response to an I/O request from the host 102 when the single controller is blocked. The write command process 400-1 then stores the cache data logs 201L and the control information logs 200L in the log backup request queue 1053.

The destage process 400-2 writes the data 201 stored in the memory 105 to the drive 110. The deduplication process 400-3 provides a deduplication function. The snapshot process 400-4 provides a snapshot creation function. Illustrations and descriptions of other processes are omitted.

As illustrated in FIG. 5, when the single controller is blocked, the cache data logs 201L and the control information logs 200L are written to the drive 110 to render the updated content of the memory 105 non-volatile, and data loss at the time of failure of the other storage controller 103 that is operating normally is prevented.

When dispatched to the CPU core 106c, the processes 400 such as the write command process 400-1 and the destage process 400-2 execute predetermined processing and output logs 400L (the cache data logs 201L and the control information logs 200L). The outputted logs 400L are registered in the log backup request queue 1053.

When the log backup process 400a is dispatched to the CPU core 106c, the logs 400L are extracted from the log backup request queue 1053 and written to the drive 110 for log backup.

In the related art, when all the processes 400 being executed are stalled at the same time in a state where the log backup request queue 1053 is full, there is no CPU core 106c for operating the log backup process 400a, and thus a deadlock occurs. In addition, in a state where the log backup request queue 1053 is full, the log backup process 400a waits for a free space for a tag for managing multiplexing of the I/Os of the drive 110, and in a case where the destage process 400-2 updates the memory 105 while holding a tag, a deadlock may occur. This is because if the log backup process 400a cannot operate, the log backup request queue 1053 remains full, the processing of the destage process 400-2 holding the tag is stopped, and the tag is not released. However, according to the present embodiment, the above-described deadlock can be avoided, and the reliability of the storage system 100 can be enhanced.

### Threshold of Log Backup Request Queue 1053 According to Embodiment

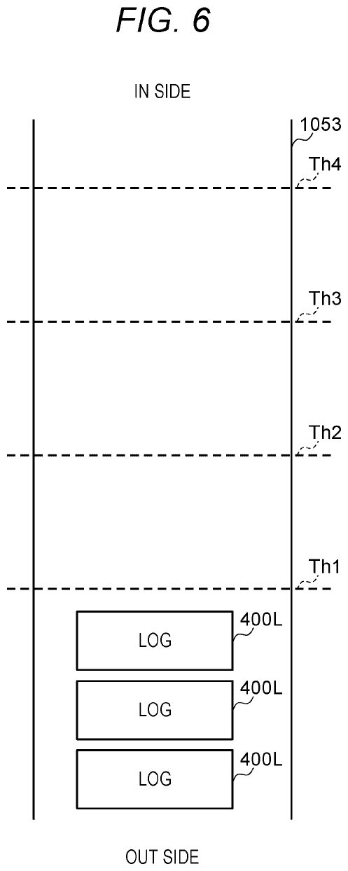

FIG. 6 is a diagram illustrating an outline of thresholds of the log backup request queue 1053 according to the embodiment. Four thresholds Th1 (first threshold), Th2 (second threshold), Th3 (third threshold), and Th4 (fourth threshold) are provided from the OUT side of the log backup request queue 1053. The thresholds Th1, Th2, Th3, and Th4 are thresholds for the capacity of the logs 400L stored in the log backup request queue 1053, and have the size relationships Th1<Th2 and Th3<Th4. The size relationship between Th2 and Th3 is not limited.

When the capacity of the logs 400L stored in the log backup request queue 1053 becomes equal to or greater than the threshold Th1, a log backup request is issued. When the log backup request is issued, the log backup process 400a dispatched to the CPU core 106c extracts the logs 400L stored in the log backup request queue 1053 and stores the logs on the drive 110.

When the capacity of the logs 400L stored in the log backup request queue 1053 becomes equal to or greater than the threshold Th2, the number of destage requests is reduced from a predetermined number determined on the basis of the status of cache data such as the dirty rate of the memory 105. Therefore, the execution frequency is reduced.

When the capacity of the logs 400L stored in the log backup request queue 1053 becomes equal to or greater than the threshold Th3, a sleep time is provided for the execution of the write command process 400-1. By providing the sleep time for the execution of the write command process 400-1, the execution interval of the write processing is expanded, and the inflow speed of the logs 400L into the log backup request queue 1053 is suppressed.

When the capacity of the logs 400L stored in the log backup request queue 1053 becomes equal to or greater than the threshold Th4, the destage request issuance is canceled. By canceling the execution of the destage process 400-2, the execution of the log backup process 400a is prioritized. The threshold Th4 is determined by adding a predetermined margin to the amount of the logs 400L generated by one start of the process 400.

As described above, when protecting the in-memory data by using the first memory protection scheme, the storage controller 103 controls the execution of the first process and the second process according to the capacity of the logs stored in the log backup request queue 1053.

### Write Processing According to Embodiment

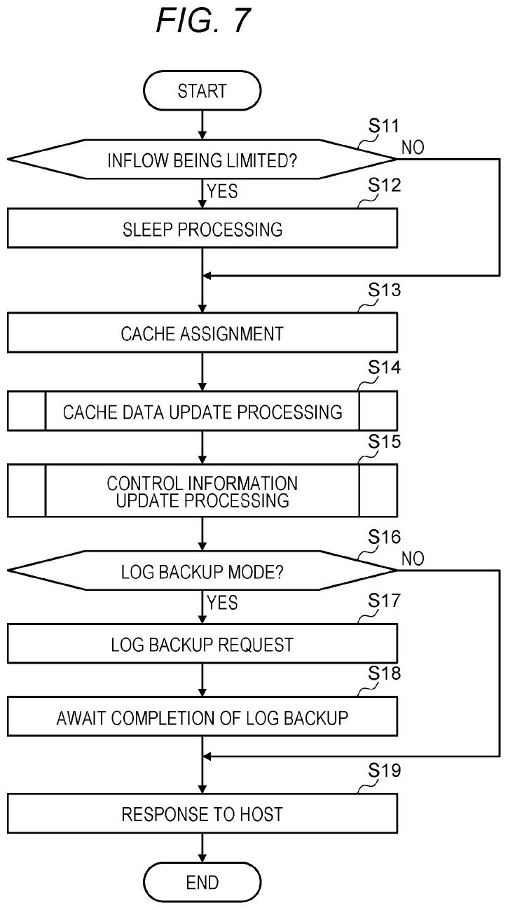

FIG. 7 is a flowchart illustrating write processing according to the embodiment. The write processing is executed each time a write request is made from the host 102.

First, in step S11, the write command process 400-1 determines whether the inflow of the logs 400L to the log backup request queue 1053 is restricted, that is, whether the capacity of the logs 400L stored in the log backup request queue 1053 is equal to or greater than the threshold Th3. The write command process 400-1 advances the processing to step S12 in a case where the inflow of the logs 400L to the log backup request queue 1053 is restricted (step S11: YES), and advances the processing to step S13 in a case where the inflow is not restricted (step S11: NO).

In step S12, the write command process 400-1 executes sleep processing to await processing for a certain period of time. Note that, while the write command process is sleeping, the CPU core 106c can execute other processes. Next, in step S13, the write command process 400-1 assigns the cache area of the memory 105 to the write data related to the I/O request from the host 102.

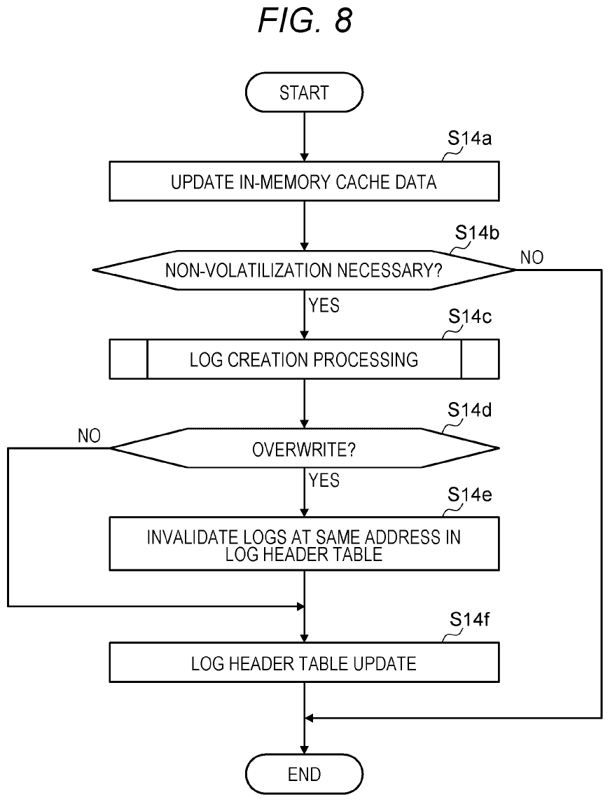

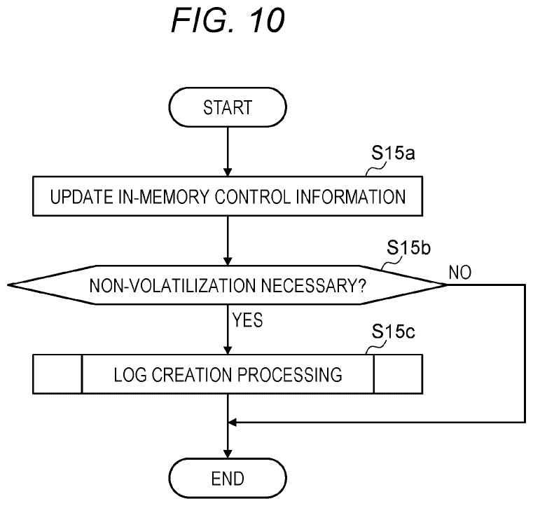

Next, in step S14, the write command process 400-1 executes cache data update processing. Details of the cache data update processing will be described below with reference to FIG. 8. Next, in step S15, the write command process 400-1 executes control information update processing. Details of the control information update processing will be described below with reference to FIG. 10.

Next, in step S16, the write command process 400-1 determines whether the mode is the log backup mode. The write command process 400-1 advances the processing to step S17 in a case where the mode is the log backup mode (step S16: YES), and advances the processing to step S19 in a case where the mode is not the log backup mode (step S16: NO).

In step S17, the write command process 400-1 issues a log backup request. In step S17, the write command process 400-1 changes the status of the logs 400L to which the log backup request has been transmitted to “backup requested”, and does not transmit the backup request again for the logs 400L which are already “backup requested”.

Next, in step S18, the write command process 400-1 waits for completion of the log backup in response to the log backup request in step S18. In step S18, because it is necessary to render content of the memory 105 which has been updated in the write processing non-volatile before the host response in step S19, the write command process 400-1 waits until the latest logs 400L generated in the write processing are backed up. Note that, while the write command process is on standby, the CPU core 106c can execute a different process.

In step S19, the write command process 400-1 transmits a response to the write request to the host 102.

### Cache Data Update Processing According to Embodiment

FIG. 8 is a flowchart illustrating cache data update processing according to the embodiment.

First, in step S14a, CPU core 106c updates the cache data (data 201) in the memory 105. Next, in step S14b, CPU core 106c determines whether non-volatilization of the cache data updated in step S14a is necessary. In a case where non-volatilization is necessary (step S14b: YES), CPU core 106c advances the processing to step S14c. On the other hand, CPU core 106c ends the cache data update processing in a case where non-volatilization is unnecessary (step S14b: NO).

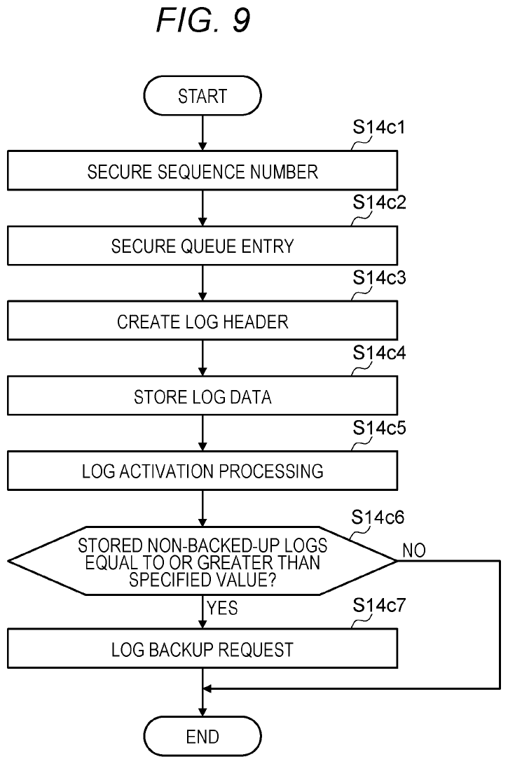

In step S14c, CPU core 106c executes log creation processing. Details of the log creation processing will be described below with reference to FIG. 9.

Next, in step S14d, CPU core 106c determines whether the update in step S14a is data overwriting. In a case where the update in step S14a is data overwriting (step S14d: YES), CPU core 106c advances the processing to step S14e. On the other hand, in a case where the update in step S14a is the new registration of data (step S14d: NO), CPU core 106c advances the processing to step S14f.

In step S14e, CPU core 106c invalidates old logs corresponding to the overwritten memory area. Next, in step S14f, CPU core 106c updates the log header table.

### Log Creation Processing According to Embodiment

FIG. 9 is a flowchart illustrating log creation processing according to the embodiment.

First, in step S14c1, CPU core 106c secures a sequence number. The sequence numbers are numbers indicating the order of creation of each log and are stored in a log header created in a subsequent step. Next, in step S14c2, CPU core 106c secures an entry in the log backup request queue 1053. Next, in step S14c3, CPU core 106c creates a log header.

Next, in step S14c4, CPU core 106c stores the logs to which the log header created in step S14c3 have been added in the entry of the log backup request queue 1053 secured in step S14c2. Next, in step S14c5, CPU core 106c activates the logs stored in step S14c4.

Next, in step S14c6, CPU core 106c determines whether the capacity of the non-backed-up logs 400L stored in the log backup request queue 1053 is equal to or greater than a specified amount, that is, equal to or greater than the threshold Th1. The “non-backed-up logs” are logs that have been enqueued in the log backup request queue 1053 and have not yet been set to the status “backup requested”.

In a case where the capacity of the non-backed-up logs 400L stored in the log backup request queue 1053 is equal to or greater than the specified amount (step S14c6: YES), CPU core 106c advances the processing to step S14c7.

On the other hand, CPU core 106c ends the log creation processing in a case where the capacity of the non-backed-up logs 400L stored in the log backup request queue 1053 is less than the specified amount (step S14c6: NO).

In step S14c7, CPU core 106c issues a log backup request of the non-backed-up logs 400L stored in the log backup request queue 1053.

### Control Information Update Processing According to Embodiment

FIG. 10 is a flowchart illustrating control information update processing according to the embodiment.

Next, in step S15a, CPU core 106c updates the control information 200 in the memory 105. Next, in step S15b, CPU core 106c determines whether non-volatilization of the control information updated in step S14a is necessary. In a case where non-volatilization of the control information updated in step S14a is necessary (step S15b: YES), CPU core 106c advances the processing to step S15c. On the other hand, CPU core 106c ends the control information update processing in a case where non-volatilization of the control information updated in step S14a is unnecessary (step S15b: NO).

In step S15c, CPU core 106c executes the log creation processing described with reference to FIG. 9.

### Process Scheduling Processing According to Embodiment

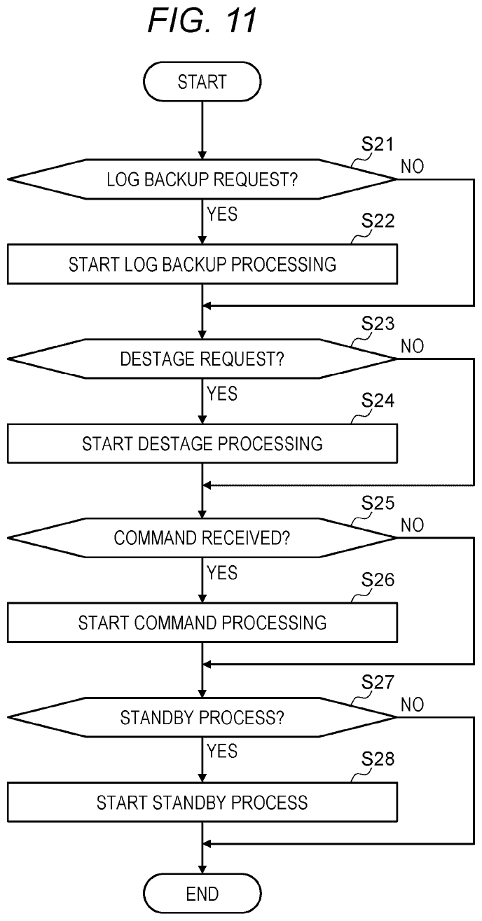

FIG. 11 is a flowchart illustrating process scheduling processing according to the embodiment. The process scheduling processing is repeatedly executed by the CPU core 106c that executes the process scheduling process. The process scheduling process starts various processing in response to requests such as commands from the host 102. However, in FIG. 11, the description is simplified by exemplifying the start of the log backup process 400a (step S22), the start of the destage process 400-2 (step S24), and the start of the command processing (step S26).

First, in step S21, the CPU core 106c determines whether there is a log backup request (step S14c7 (FIG. 9)). In a case where there is a log backup request (step S21: YES), the CPU core 106c advances the processing to step S22. On the other hand, in a case where there is no log backup request (step S21: NO), the CPU core 106c advances the processing to step S23.

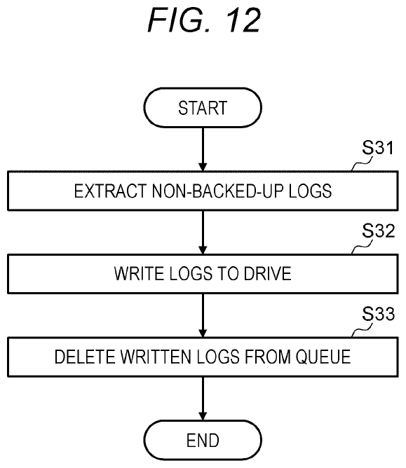

In step S22, the CPU core 106c starts log backup processing (FIG. 12) to be described below.

Next, in step S23, the CPU core 106c determines whether there is a destage request. In a case where there is a destage request (step S23: YES), the CPU core 106c advances the processing to step S24. On the other hand, in a case where there is no destage request (step S23: NO), the CPU core 106c advances the processing to step S25.

In step S24, the CPU core 106c dispatches the destage process 400-2 to the CPU core 106c to start the destage processing.

Next, in step S25, the CPU core 106c determines whether a command has been received from the host 102. In a case where the CPU core 106c has received the command (step S25: YES), the processing advances to step S25. On the other hand, in a case where the CPU core 106c has not received a command (step S25: NO), the processing advances to step S26.

In step S26, the CPU core 106c starts processing according to the received command.

Next, in step S27, the CPU core 106c determines whether there is a standby process 400. In a case where there is a standby process 400 (step S27: YES), the CPU core 106c advances the processing to step S28. On the other hand, the CPU core 106c ends the process scheduling processing in a case where there is no process 400 awaiting execution (step S27: NO).

In step S28, the CPU core 106c starts the standby process 400.

### Log Backup Processing According to Embodiment

FIG. 12 is a flowchart illustrating log backup processing according to the embodiment. The log backup processing is executed by the log backup process 400a.

First, in step S31, the log backup process 400a extracts a predetermined amount of the non-backed-up logs 400L stored in the log backup request queue 1053. Next, in step S32, the log backup process 400a writes the logs 400L extracted in step S31 to the drive 110 at the storage destination managed by the control information log storage destination management table 200a or the cache data log storage destination management table 200b. Next, in step S33, the log backup process 400a deletes the logs 400L written in the drive 110 in step S32 from the log backup request queue 1053.

### Destage Speed Adjustment Processing According to Embodiment

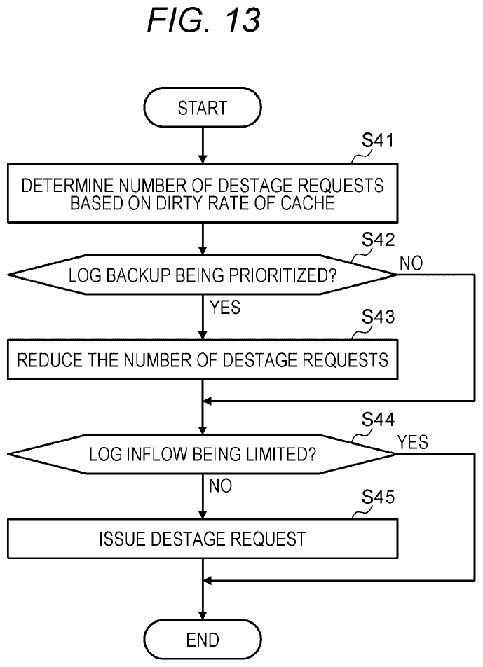

FIG. 13 is a flowchart illustrating destage speed adjustment processing according to the embodiment. The destage speed adjustment processing is executed by the destage speed adjustment process.

First, in step S41, the destage speed adjustment process determines the number of destage requests on the basis of the dirty rate of the data 201 cached in the memory 105. Here, the dirty rate=the dirty cache amount/the total cache capacity, and the higher the dirty rate, the more the number of destage requests is increased. Note that the number of destage requests is not limited to the dirty rate, and may be a value calculated on the basis of another index indicating the status of cache data or the like, or may be a constant value.

Next, in step S42, the destage speed adjustment process determines whether log backup is being prioritized, that is, whether the capacity of the logs 400L stored in the log backup request queue 1053 is equal to or greater than the threshold Th2. The destage speed adjustment process advances the processing to step S43 in a case where log backup is being prioritized (step S42: YES). On the other hand, in the destage speed adjustment process, in a case where the log backup priority is not being prioritized (step S42: YES), the process advances to step S44.

In step S43, the destage speed adjustment process decreases the number of destage requests determined in step S41 by a predetermined number. In step S43, because the free space of the log backup request queue 1053 is equal to or less than a certain value, the destage execution frequency of is lowered in order to prioritize log backup.

Next, in step S44, the destage speed adjustment process determines whether the log inflow is restricted, that is, whether the capacity of the logs 400L stored in the log backup request queue 1053 is equal to or greater than the threshold Th4. The destage speed adjustment process ends the destage speed adjustment processing in a case where the log inflow is restricted (step S44: YES). In the case of NO in step S44, the capacity of the logs 400L stored in the log backup request queue 1053 has reached the threshold Th4. Therefore, the destage speed adjustment process cancels the execution of the destage speed adjustment process (step S45) for writing the cache data cached in the memory 105 to the drive 110 in the first process.

On the other hand, the destage speed adjustment process advances the processing to step S45 in a case where the log inflow is not restricted (step S44: NO).

In step S45, the destage speed adjustment process issues destage requests for the data 201 cached in the memory 105 in a number corresponding to the number of destage requests finally determined through steps S41 and S43.

Note that the data protection in cache memory using the first memory protection scheme described above is applicable even under normal circumstances, not only when one storage controller of the duplicated storage controllers is blocked, but also when both storage controllers are normal.

### Advantageous Effects of Embodiment

In the above embodiment, when the in-memory data is to be protected using the first memory protection scheme, the execution of a first process for storing logs in the queue and a second process for extracting logs from the queue and writing the logs to the storage medium is controlled according to the capacity of the logs stored in the queue. Therefore, in the writeback of the storage system, it is possible to prevent logs from accumulating in the queue that stores the logs of the updated content of the cache memory. In addition, deadlocks of the memory non-volatile function can be avoided, and the system can be operated safely.

In the above embodiment, switching is performed between using either the first memory protection scheme or the second memory protection scheme according to the operating state of the other storage controller, and the in-memory data is protected using the switched first memory protection scheme or second memory protection scheme. Therefore, at the time of blockage due to the failure of one storage controller, it is possible to prevent the logs from accumulating in the queue for storing the logs of the updated content in the cache memory while suppressing a reduction in reliability by performing the memory non-volatilization using the first memory protection scheme instead of the second memory protection scheme. In addition, high performance can be realized by executing an arbitrary job using all the CPU cores in a normal state, and high reliability can be realized by means of the first memory protection scheme when one storage controller is blocked. That is, it is possible to realize a storage system that is high performance in a normal state and that is subject to a minimal drop in performance in a fault state.

In the above embodiment, when the in-memory data is to be protected using the first memory protection scheme, the execution of the destage process of the first process is canceled when the capacity of the logs stored in the queue is equal to or greater than the fourth threshold. On the other hand, when the capacity of the logs stored in the queue is less than the fourth threshold, the destage process is performed. Therefore, when the capacity of the logs is equal to or greater than the fourth threshold, log accumulation in the queue can be quickly resolved by executing only the log backup, without executing destaging.

In the above embodiment, when the in-memory data is protected using the first memory protection scheme, the second process (log backup process 400a) is executed when the capacity of the logs stored in the queue is equal to or greater than the first threshold which is smaller than the fourth threshold. On the other hand, when the capacity of the logs stored in the queue is less than the first threshold, the execution of the second process is canceled. Therefore, when the capacity of the logs is equal to or greater than the first threshold, log accumulation in the queue can be suppressed by preferentially executing log backup.

In the above embodiment, when the in-memory data is to be protected using the first memory protection scheme, the destage process is executed at a predetermined frequency when the capacity of the logs stored in the queue is less than the second threshold which is greater than the first threshold and less than the fourth threshold. On the other hand, when the capacity of the logs stored in the queue is equal to or greater than the second threshold, the destage process is executed at a frequency lower than the predetermined frequency. Therefore, when the capacity of the logs is equal to or greater than the second threshold, log accumulation in the queue can be suppressed by lowering the frequency of collective writing of the cache data destage to reduce the drive load.

In addition, in the above-described embodiment, when the in-memory data is to be protected using the first memory protection scheme, and when the capacity of the logs stored in the queue is equal to or greater than the third threshold, the execution interval is increased at the time of executing the write process of the first process. On the other hand, when the capacity of the logs stored in the queue is less than the third threshold, the execution interval is not increased at the time the write process is to be executed. Therefore, by lowering the inflow speed of the logs into the queue (placing write I/Os on standby), the log generation speed can be lowered, and the logs accumulated in the queue can be suppressed.

In the above embodiment, the storage medium to which the logs are to be backed up is the drive 110. Therefore, by using a partial area of a user data drive for the log backup, high performance can be obtained at low cost.

Although several embodiments have been described above, these embodiments are examples for the purpose of describing the present invention, there being no intention to limit the scope of the present invention only to these embodiments. The present invention can also be implemented in various other modes, for example, a mode in which a part of the configuration of each of the above-described embodiments is deleted, a mode in which at least a part of the configuration is replaced, a mode in which a configuration is added, and a mode in which a part or all of each of the embodiments are combined.

What is claimed is:

1. A storage system, comprising:
a non-volatile storage device for storing user data; and a plurality of storage controllers for controlling reading from and writing to the storage device,
wherein each of the plurality of storage controllers includes a processor and a memory,
wherein the storage controller includes a first memory protection scheme in which logs related to the writing and updating of data in the memory are generated and stored in a queue and in which the logs are extracted from the queue and written to a non-volatile storage medium to protect the data in the memory, and
wherein, when the data in the memory is to be protected using the first memory protection scheme, the storage controller controls, according to the capacity of the logs stored in the queue, the execution of a first process for storing the logs in the queue and a second process for extracting the logs from the queue and writing the logs to the storage medium.

2. The storage system according to claim 1,
wherein the storage controller further includes a second memory protection scheme in which the data in the memory is protected by copying the data in the memory to another memory of the other storage controller corresponding to the storage controller, and
wherein the storage controller switches between using either the first memory protection scheme or the second memory protection scheme according to an operating state of the other storage controller, and protects the data in the memory by using the switched first memory protection scheme or second memory protection scheme.

3. The storage system according to claim 1,
wherein, when the data in the memory is to be protected using the first memory protection scheme,
the storage controller cancels the execution of a destage process for writing cache data cached in the memory to the storage device in the first process when the capacity of the logs stored in the queue is equal to or greater than a fourth threshold, and executes the destage process when the capacity of the logs stored in the queue is less than the fourth threshold.

4. The storage system according to claim 3,
wherein, when the data in the memory is to be protected using the first memory protection scheme,
the storage controller executes the second process when the capacity of the logs stored in the queue is equal to or greater than a first threshold which is smaller than the fourth threshold, and
cancels the execution of the second process when the capacity of the logs stored in the queue is less than the first threshold.

5. The storage system according to claim 4,
wherein, when the data in the memory is to be protected using the first memory protection scheme, the storage controller
executes the destage process at a predetermined frequency when the capacity of the logs stored in the queue is less than a second threshold which is greater than the first threshold and less than the fourth threshold, and
executes the destage process at a frequency lower than the predetermined frequency when the capacity of the logs stored in the queue is equal to or greater than the second threshold.

6. The storage system according to claim 4,
wherein, when the data in the memory is to be protected using the first memory protection scheme, and
when the capacity of the logs stored in the queue is equal to or greater than a third threshold that is greater than the first threshold and less than the fourth threshold, the storage controller increases an execution interval at the time of executing, in the first process, a write process for writing data related to a write request from a host to the storage device, and
when the capacity of the logs stored in the queue is less than the third threshold, the storage controller does not increase the execution interval at the time of executing the write process.

7. The storage system according to claim 1,
wherein the storage medium is the storage device.

8. A data protection method executed by a storage system that includes a non-volatile storage device for storing user data, and a plurality of storage controllers for controlling reading from and writing to the storage device, each of the plurality of storage controllers including a processor and a memory, and the storage controller including a first memory protection scheme in which logs related to the writing and updating of data in the memory are generated and stored in a queue and in which the logs are extracted from the queue and written to a non-volatile storage medium to protect the data in the memory,
the data protection method including processing in which,
when the data in the memory is to be protected using the first memory protection scheme, the storage controller controls, according to the capacity of the logs stored in the queue, the execution of a first process for storing the logs in the queue and a second process for extracting the logs from the queue and writing the logs to the storage medium.
